(19) United States
(12) Patent Application Publication
(10) Pub. No.: US 2008/0215290 A1
(43) Pub. Date: Sep. 4, 2008

(54) Determining a location based advertising campaign

(75) Inventors: Monte Zweben, San Francisco, CA (US); Scott Hines, San Francisco, CA (US); Eugene Davis, Hillsborough, CA (US)

Correspondence Address: VAN PELT, YI & JAMES LLP, 10050 N. FOOTHILL BLVD #200, CUPERTINO, CA, 95014, US

(73) Assignee: Seesaw Networks, Inc.

(21) Appl. No.: 11/713,538

(22) Filed: Mar. 1, 2007

(51) Int. Cl. G06F 17/18

(52) U.S. Cl. 702/179

(57) ABSTRACT

A method of determining a location based advertising campaign is disclosed. A specification of location based advertising campaign characteristics is received. Available spots in an advertising supply are scored based on the specification. Selected spots are automatically determined from among the available spots in physical locations to include in the location based advertising campaign, based on an advertising budget and the scoring of the available spots. A description of the location based advertising campaign for displaying the selected spots is outputted.

### BACKGROUND OF THE INVENTION

There are hundreds of different digital media companies, each focusing upon establishing the presence of location based advertising or digital signs in some segment of the locales where people might view them. These are called digital sign networks or DSN's. The digital signs in these DSN's present content as well as advertising to their viewers. Placing location based advertising across many DSN's is therefore complex, since there is no common frame of reference for how to uniformly target, plan, traffic, measure, and pay for this campaign across the diverse networks. Therefore, there exists a need to determine a location based advertising campaign efficiently for an advertiser.

### BRIEF DESCRIPTION OF THE DRAWINGS

Various embodiments of the invention are disclosed in the following detailed description and the accompanying drawings.

FIG. 1 is a flowchart illustrating a general flow for location based advertising.

FIG. 2 is a block diagram illustrating an embodiment of the supply for a location based advertising campaign.

FIG. 3 is a diagram of a system to determine a location based advertising campaign for an advertiser, purchase a location based advertising campaign for an advertiser, and measure the effectiveness of a location based advertising campaign for an advertiser.

FIG. 4 is a flowchart illustrating an embodiment of a process to determine a location based advertising campaign from an advertiser's specification of campaign characteristics.

FIG. 5 is a flowchart illustrating an embodiment of a process for a location based advertising campaign to be determined from a set of Distribution Lists.

FIG. 6 is a block diagram illustrating an embodiment of an advertiser's portions of the process for the distribution of location based advertising.

FIG. 7 is a flowchart illustrating an embodiment of a process to distribute a location based advertising campaign.

FIG. 8 is a flowchart illustrating an embodiment of a process to determine, reserve and book a location based advertising campaign.

FIG. 9 is a flowchart illustrating an embodiment of a process for the storyboard creative editorial cycle.

FIG. 10 is a flowchart illustrating an embodiment of a process for the final creative editorial cycle.

FIG. 11A is a flowchart illustrating an embodiment of a process for storyboard creative quality assurance.

FIG. 11B is a flowchart illustrating an embodiment of a process for final creative quality assurance.

FIG. 12 is a flowchart illustrating an embodiment of a process for a location based advertising campaign launch and end.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

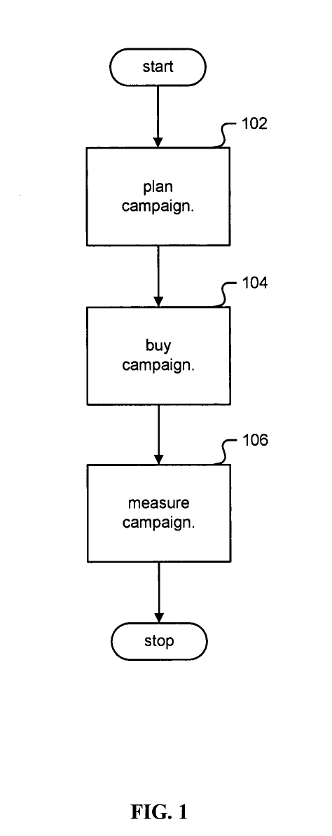

FIG. 1 is a flowchart illustrating a general flow for location based advertising. In a step 102, an advertiser plans and determines a location based advertising campaign. In a step 104, an advertiser buys and launches a location based advertising campaign. In a step 106, an advertiser is given a measurement of the effectiveness of the location based advertising campaign.

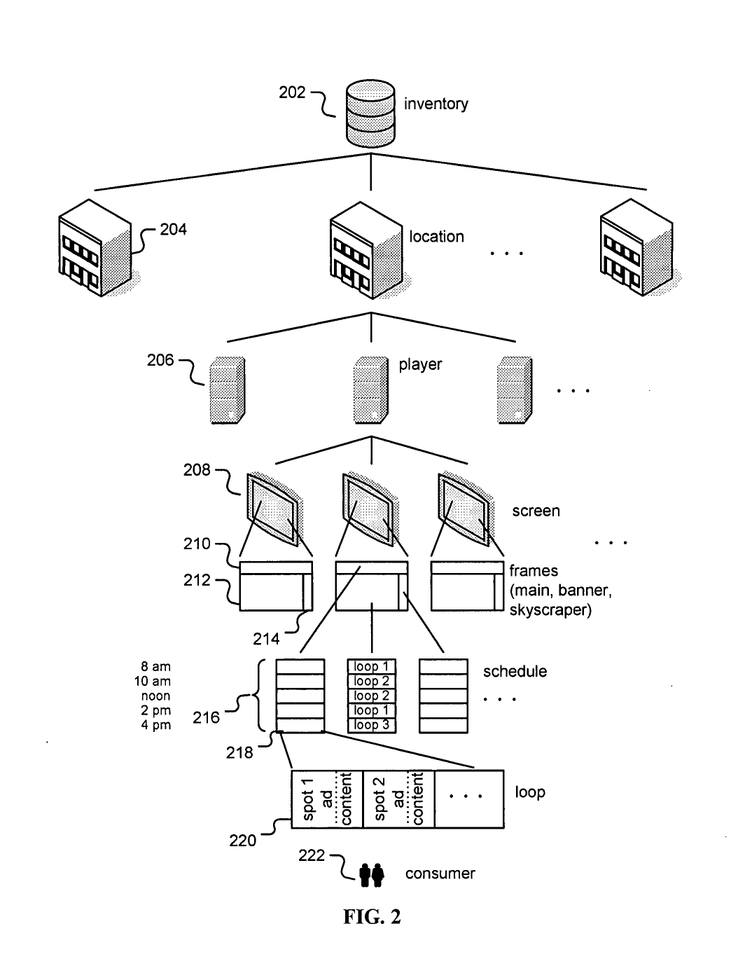

FIG. 2 is a block diagram illustrating an embodiment of the supply for a location based advertising campaign. In the example shown, location based advertising inventory 202 is comprised of physical locations 204 for view by consumer 222. In some embodiments a physical location 204 could be determined by a geographic specification that represents a combination of:
address—a street, city, county, state/province, postal code, and/or country;
geographic regions represented as areas surrounding, or within a fixed radius of, specific input addresses;
latitude and longitude pair;
Designated Market Areas, or DMA; and
major metropolitan areas, or Combined Statistical Areas, or CSA.

In some embodiments a physical location 204 can have a category specification associated with it that represents a combination of
fixed hierarchy, such as “grocery”, “university”, and “bars/restaurants”, with subcategories like “sports bar”, “family restaurant” and “fast food”; and
tags/keyword associations, such as “kiosk”, “fantasy”, or “extreme”.

Each physical location 204 contains at least one player 206, a server for location based advertising at that location. At a specific physical location 204, there may be a plurality of players 206, for example, one player 206 for a pharmacy within a supermarket, and another player 206 for a supermarket checkout stand. In some embodiments, a player 206 will have a venue specification associated with it that represents a combination of:
demographic information about the consumers 222 for player 206, including average age, gender, income and ethnicity. In some embodiments this information is a percentage of the traffic that falls into a standard set of demographic groupings, for example:
   Male—53%
   Female—47%
   Age under 17—6%
   Age 18-24—14%
   Age 25-34—19%
   Age 35-44—18%
   Age 45-54—14%
   Age 55-64—12%
   Age 65+—17%;
physical placement information of associated location based advertising for player 206 within the location 204, including whether audio advertising is available;
traffic information about the consumers 222 of associated location based advertising for player 206, for example the weekly volume of consumers 222 that pass by the associated location based advertising;
awareness information about the consumers 222 of associated location based advertising for player 206, for example a ratio of consumers 222 who recall the associated location based advertising to the total consumers 222 that pass by the associated location based advertising;
net impressions information about the consumers 222 of associated location based advertising for player 206, where

Net impressions=Traffic×Awareness,
the number of consumers 222 who recall the associated location based advertising in a given period; and
pricing information for advertisers of associated location based advertising for player 206, for example pricing in terms cost per net impressions, or CPM.

Each player 206 displays location based advertising to at least one screen 208. A player 206 may have a plurality of screens 208, in which case it will display the location based advertising at the same time on each screen 208. Each screen 208 can be made of one or more frames, which when there are more are arranged in a specific fashion: banner (along the top) 210, skyscraper (along the side) 214 and main screen 212. Each frame 210, 212, and 214 is assigned a schedule 216, which is a table of specified location based advertising loops 218 assigned to times of a specified day. Each loop 218 contains a specified number of spots 220, where a spot 220 is made up of an advertisement, content or both advertisement and content. In some embodiments the spot 220 can have a specification associated with it that represents a combination of:
specified frame 210, 212, 214;
time for the spot, for example 15 or 30 seconds;
aspect ratio of the spot; and
media type of the spot.

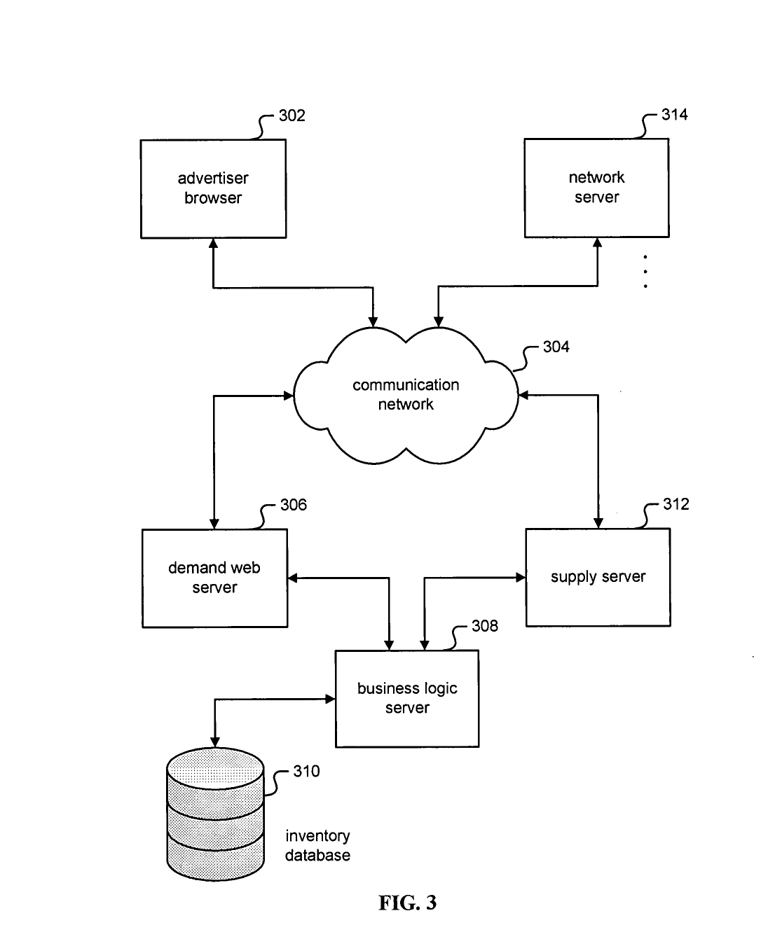

FIG. 3 is a diagram of a system to determine a location based advertising campaign for an advertiser, purchase a location based advertising campaign for an advertiser, and measure the effectiveness of a location based advertising campaign for an advertiser. An advertiser can use advertiser browser 302 to connect by communication network 304 to a demand web server 306. Communication network 304 may be a public or private network and/or combination thereof, for example the Internet, an Ethernet, serial/parallel bus, intranet, NAS, SAN, LAN, WAN, and other forms of connecting multiple systems and/or groups of systems together. Demand web server 306 guides the advertiser through advertiser browser 302 to form a specification of the advertiser's preferences for location based advertising campaign characteristics and transmits it to business logic server 308. In some embodiments, a specification of the advertiser's preferences may include a combination of geographic specifications, category specifications, venue specifications and the campaign time.

Business logic server 308 receives the advertiser's location based advertising campaign characteristics. Business logic server 308 also accesses inventory database 310 of the available location based advertising inventory. Business logic server 308 may update the inventory database 310 using a supply server 312, which is connected through communications network 304 to various network servers 314. In some embodiments the network server 314 may include player 106. In some embodiments demand web server 306, business logic server 308, inventory database 310 and supply server 312 may be on one server, or spread out across multiple servers.

Business logic server 308 uses the received location based advertising campaign characteristics and inventory database 310 to determine the location based advertising campaign. When the advertiser has purchased the location based advertising campaign, the business logic server 308 updates the inventory database 310 using supply server 312, and then executes the location based advertising campaign with the relevant network servers 314.

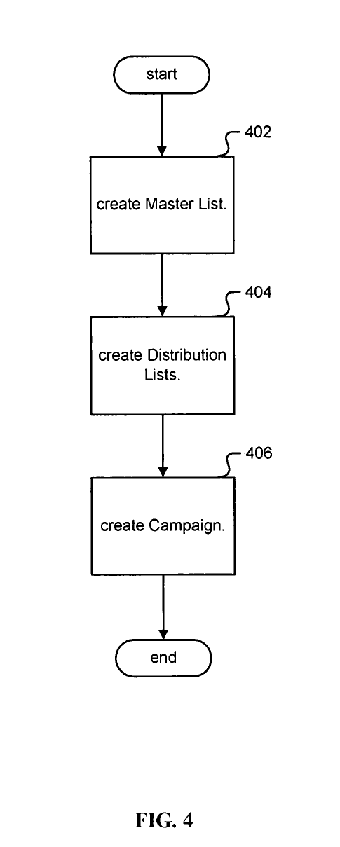

FIG. 4 is a flowchart illustrating an embodiment of a process to determine a location based advertising campaign from an advertiser's specification of campaign characteristics. In some embodiments, the process of FIG. 4 is included in 102 of FIG. 1. The process may be implemented in business logic server 308. The advertiser's specifications can be divided into three types of campaign attributes: Boolean attributes, independent gradient attributes, and distribution gradient attributes. In some embodiments, a campaign's Boolean attributes can include:
date range;
geographic specification;
category specification;
minimum CPM; and
audio requirements,
   a campaign's independent gradient attributes can include demographics, and a campaign's distribution gradient attributes can include:
geographic specification—specifying a distribution of a plurality of geographic locations, including an even distribution or an uneven distribution;
category specification—specifying a distribution of a plurality of categories, including an even distribution or an uneven distribution; and
campaign week specification—specifying a distribution of location based advertising, including an even distribution through all the weeks, a “front-end” distribution with more location based advertising in earlier weeks over later weeks, and a “back-end” distribution with more location based advertising in later weeks over earlier weeks.

In a step 402, the venues that are good matches for the advertiser's specification with an available loop, or Candidates, are selected from the inventory database 310 by filtering those that meet the campaign's Boolean attributes. Each Candidate is assigned an independent priority weighting, based on the campaign's independent gradient attributes. Each Candidate and its associated price is inserted into a collection, ordered by the independent priority weighting, called a Master List. In some embodiments, the associated price can be either expressed in CPM or dollar cost.

In some embodiments, the campaign's independent gradient attribute used is demographic: for each target demographic, multiply its independent priority weighting by its demographic percent and sum the result, for example for an advertiser targeting males, a venue that achieves 60% male gets a score of 0.6, a venue that achieves 30% male gets a score of 0.3.

In a step 404, a collection called a Distribution List is created for each of the campaign's distribution gradient attributes. The Candidates and associated price in the Master List are subdivided into each Distribution List, and ordered by the independent priority weighting. A Candidate could be in more than one Distribution List.

In some embodiments, a detailed example can be given with an advertiser specifying a campaign distribution attribute for geography and category, with 60% New York and 40% San Francisco, and 50% Grocery and 50% University. In the detailed example, the Master List with the following ordered Candidates and associated price:
(Loop 1) New York, Week 1, Grocery, $1;
(Loop 2) New York, Week 2, Grocery, $2;
(Loop 3) San Francisco, Week 1, University, $1;
(Loop 4) New York, Week 2, Grocery, $3; and
(Loop 5) San Francisco, Week 4, University, $1,
   would be divided into an ordered New York Distribution List:
(Loop 1) New York, Week 1, Grocery, $1;
(Loop 2) New York, Week 2, Grocery, $2; and
(Loop 4) New York, Week 2, Grocery, $3,
   an ordered San Francisco Distribution List:
(Loop 3) San Francisco, Week 1, University, $1; and
(Loop 5) San Francisco, Week 4, University, $1,
   an ordered Grocery Distribution List:
(Loop 1) New York, Week 1, Grocery, $1;
(Loop 2) New York, Week 2, Grocery, $2; and
(Loop 4) New York, Week 2, Grocery, $3,
   and an ordered University Distribution List:
(Loop 3) San Francisco, Week 1, University, $1; and
(Loop 5) San Francisco, Week 4, University, $1.

In a step 406, the location based advertising campaign, or Campaign, is determined by adding the next affordable Candidate from the appropriate Distribution List to follow the campaign distribution gradient attribute specified. The resultant Campaign is the determined location based advertising campaign for the advertiser.

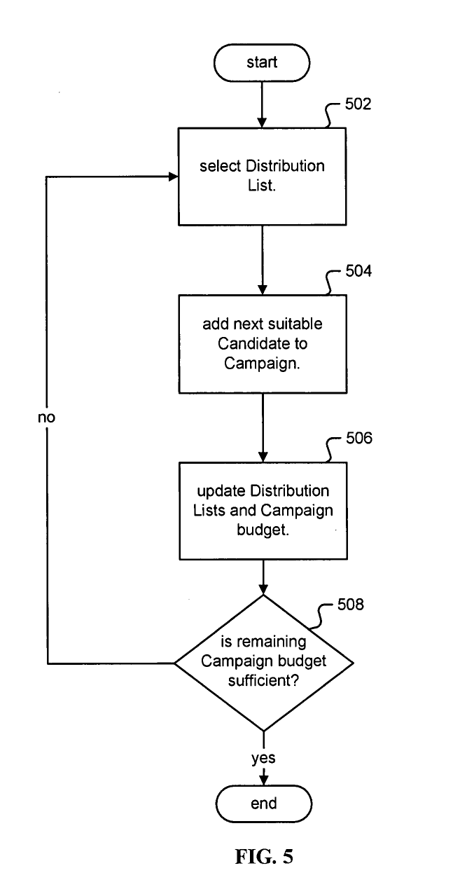

FIG. 5 is a flowchart illustrating an embodiment of a process for a location based advertising campaign to be determined from a set of Distribution Lists. In some embodiments, the process of FIG. 5 is included in 406 of FIG. 4. The process may be implemented in business logic server 308.

In a step 502, a Distribution List is selected based on an advertiser's campaign's distribution gradient attributes. In the detailed example, the New York Distribution List will be selected if the Campaign has less than 60% of its loops with a venue in New York. There may be a plurality of Distribution Lists that could be selected at one time, and in some embodiments the Distribution List with the highest independent priority weighting top Candidate can be selected.

In a step 504, the top Candidate of the ordered Distribution List will be added to the Campaign if the associated price of the Candidate is less than or equal to the remaining Campaign budget. If the top Candidate's associated price is greater than the remaining Campaign budget, remove the top Candidate and repeat step 504 with the next Candidate on the Distribution List. In the detailed example, if the New York Distribution List was selected and the remaining Campaign budget was $3, the top Candidate may be (Loop 1) in New York, Week 1, Grocery with an associated price of $1, so that (Loop 1) would be added to the Campaign.

In a step 506, the added Candidate from step 504 is removed from all Distribution Lists and the Campaign budget is updated to reflect the added Candidate's associated price. In the detailed example, (Loop 1) would be removed from the New York Distribution List and the Grocery Distribution List, and the remaining Campaign budget would be updated to be $2.

If it is determined at step 508 that the remaining Campaign budget is not less than a prespecified threshold, then control is transferred back to step 502. If it is determined at step 508 that the remaining Campaign budget is less than a prespecified threshold, then the resultant Campaign is the determined location based advertising campaign for the advertiser.

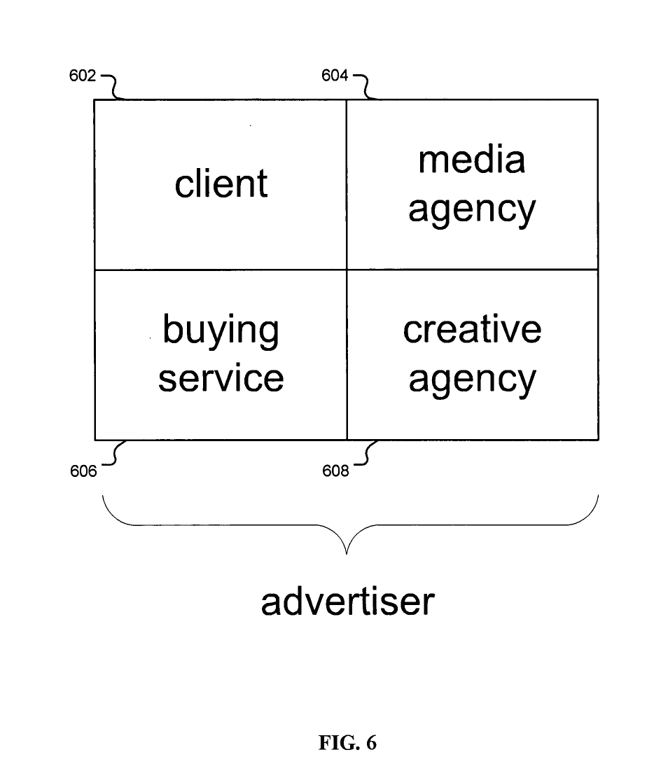

FIG. 6 is a block diagram illustrating an embodiment of an advertiser's portions of the process for the distribution of location based advertising. An advertiser is made up of one or more team members. Each team member would assume one or more of the portions shown, client 602, media agency 604, buying service 606, and creative agency 608. Each portion has a set of privileges associated with the portion that defines what the associated team member with the portion can do, and what information the associated team member can receive.

Privileges that define what the associated team member with the portion can do include:
Add Team Members: adding a new team member and associate the new team member with a portion. This privilege might be assigned to a client 602, or a lead coordinator of the location based advertising campaign from media agency 604;
Upload Creative Only: upload creative assets (“creative”) but not view a location based advertising campaign. This privilege might be assigned to a specialist at a creative agency 608, who is concerned only with specific creative works;
View Campaigns: access a location based advertising campaign. This privilege might be assigned to a client 602, media agency 604, buying service 606, and a manager at a creative agency 608;
Can Upload: upload creative to a location based advertising campaign. This privilege would be assigned to those with a View Campaigns privilege, for example a creative agency 608;
Can Edit: edit a location based advertising campaign. This privilege would be assigned to those with a View Campaigns privilege, for example a media agency 604; and
Can Buy: make financial decisions for a location based advertising campaign. This privilege would be assigned to those with a View Campaigns privilege, for example a buying service 606 or client 602.

Privileges that define what information the associated team member can receive include:
Traffic Notification: be notified of distribution of a location based advertising campaign. This privilege might be assigned to a client 602 or creative agency 608;
Planning/Buying Notification: be notified of planning and purchase of a location based advertising campaign. This privilege might be assigned to a client 602, media agency 604 or buying service 606; and
Billing: be notified of location based advertising campaign billing. This privilege might be assign to a client 602 or media agency 604.

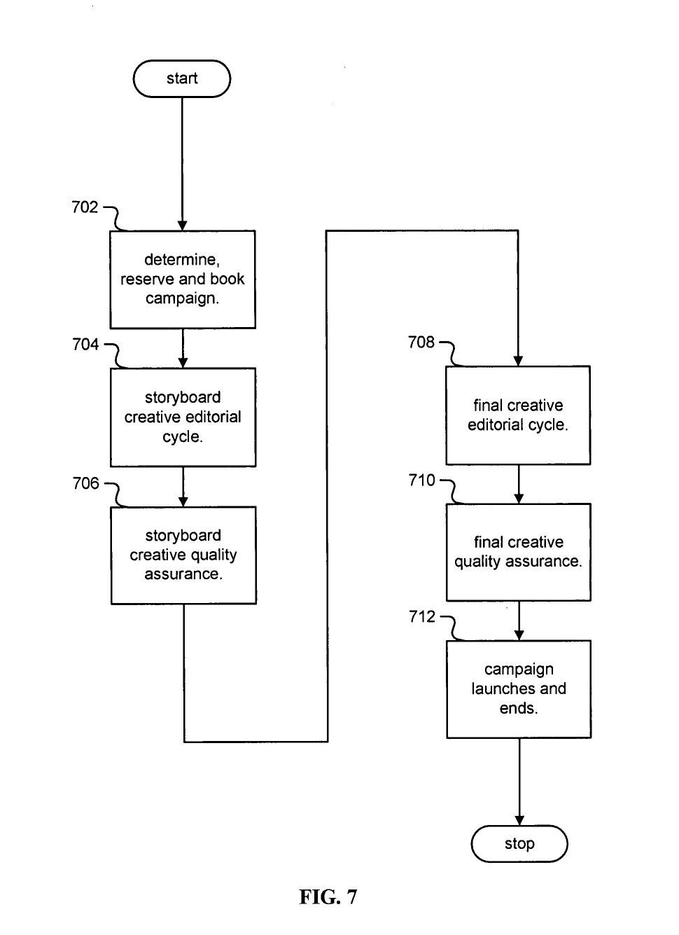

FIG. 7 is a flowchart illustrating an embodiment of a process to distribute a location based advertising campaign. In some embodiments, the process of FIG. 7 is included in 104 of FIG. 1. The process may be implemented in business logic server 308.

In a step 702, the advertiser determines the location based advertising campaign using the process of FIG. 4. The advertiser then has the option to reserve the campaign and associated inventory for a reservation period to consider the campaign. In some embodiments, the reservation period is 48 hours. The advertiser can then financially commit, or “book”, the campaign.

In a step 704, the advertiser's team members collaborate on the storyboard creative. Storyboard creative includes idea and marketing content for the location based advertising campaign. An editorial cycle of review, change and approval will iterate until the advertiser is satisfied with the storyboard creative.

In a step 706, the location based advertising network reviews the storyboard creative for quality assurance and technical compliance with the player 206 and screen 208. An editorial cycle of review, change and approval will iterate until the location based advertising network and advertiser are satisfied.

In a step 708, the advertiser's team members collaborate on the final creative. Final creative includes look and feel, and technical adherence of the advertising for the location based advertising campaign. An editorial cycle of review, change and approval will iterate until the advertiser is satisfied with the final creative.

In a step 710, the location based advertising network reviews the final creative for quality assurance and technical compliance with the player 206 and screen 208. An editorial cycle of review, change and approval will iterate until the location based advertising network and advertiser are satisfied.

In a step 712, the location based advertising network launches the approved location based advertising campaign. The advertiser is updated periodically with a status until the campaign ends, when a final status and affidavit are sent to the advertiser.

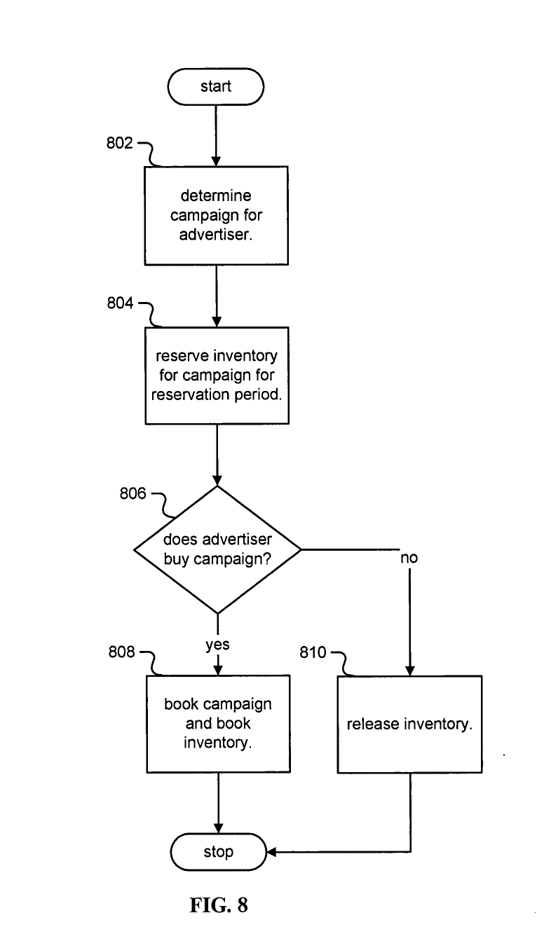

FIG. 8 is a flowchart illustrating an embodiment of a process to determine, reserve and book a location based advertising campaign. In some embodiments, the process of FIG. 8 is included in 702 of FIG. 7. The process may be implemented in business logic server 308.

In a step 802, the advertiser determines the campaign, using the process of FIG. 4. In a step 804, the business logic server 308 updates inventory 310 to reserve the campaign. In some embodiments, business logic server 308 maintains a local count of inventory 310 that business logic server 308 is allowed to purchase from location based advertising networks with venues that are a part of the campaign. By maintaining a local count, the location based advertising networks do not need to be notified at this step. The advertiser is reminded to book, or purchase, the campaign before the reservation period expires. In some embodiments, the reminders are sent using e-mail.

If it is determined in a step 806 that the advertiser wishes to buy the location based advertising campaign, then control is transferred to step 808. If it is determined in a step 806 that the advertiser does not wish to buy the location based advertising campaign by cancelling the reservation or allowing the reservation to expire, then control is transferred to step 810.

In a step 808, the location based advertising networks book the inventory by notifying the location based advertising networks and booking the periods for the associated venues. In some embodiments, the business logic server 308 permanently reduces a local count of inventory 310 that business logic server 308 is allowed to book. In a step 810, the business logic server 308 releases its count of inventory 310. In some embodiments, the business logic server 308 updates its local count of inventory 310 so that another advertiser can reserve or book the venues.

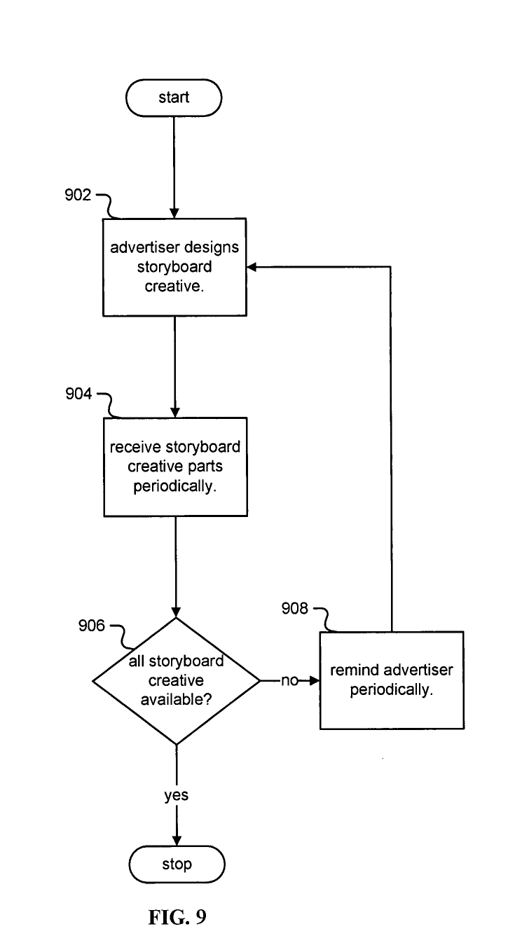

FIG. 9 is a flowchart illustrating an embodiment of a process for the storyboard creative editorial cycle. In some embodiments, the process of FIG. 9 is included in 704 of FIG. 7. The process may be implemented in demand web server 306, business logic server 308, or both.

In a step 902, the advertiser designs the storyboard creative. Demand web server 306, business logic server 308, or both may be used to facilitate the design of the storyboard creative between various members of the advertiser's team.

In a step 904, the members of the advertiser's team will submit a version of part or all of the storyboard creative to demand web server 306, business logic server 308, or both. In some embodiments, submission will use file transfer protocol (FTP) or secure FTP for uploading. The members of the advertiser's team will then review the storyboard creative to see if the story creative is to be made available.

If it is determined at step 906 that the storyboard creative is not completely available, then control is transferred to step 908. Otherwise, the storyboard creative is made available and the storyboard creative editorial cycle is considered complete. In a step 908, at the end of a repeating specified period (the “storyboard creative reminder period”) the advertiser is reminded to make the storyboard creative available well before the campaign launch. In some embodiments, e-mail is used to remind the advertiser.

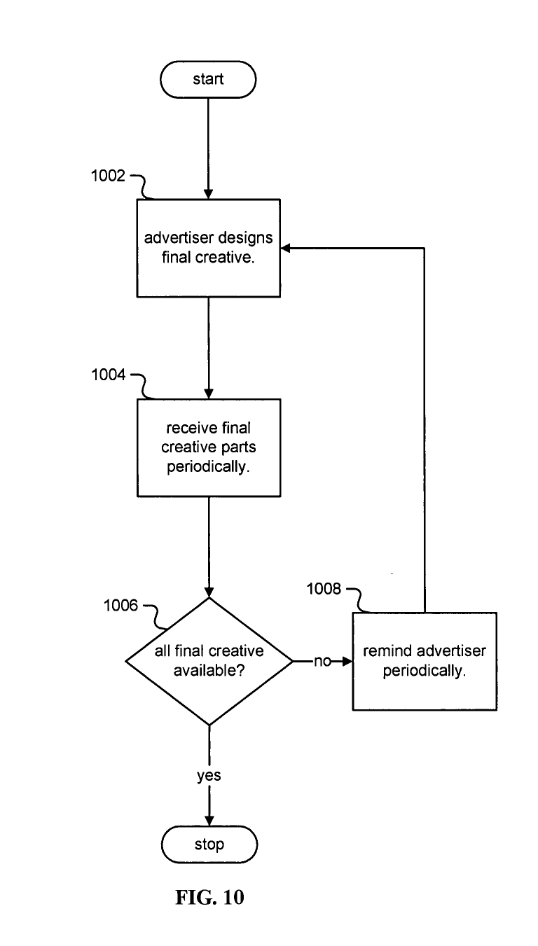

FIG. 10 is a flowchart illustrating an embodiment of a process for the final creative editorial cycle. In some embodiments, the process of FIG. 10 is included in 708 of FIG. 7. The process may be implemented in demand web server 306, business logic server 308, or both.

In a step 1002, the advertiser designs the final creative. Demand web server 306, business logic server 308, or both may be used to facilitate the design of the final creative between various members of the advertiser's team.

In a step 1004, the members of the advertiser's team will submit a version of part or all of the final creative to demand web server 306, business logic server 308, or both. In some embodiments, submission will use FTP or secure FTP for uploading. The members of the advertiser's team will then review the final creative to see if the story creative is to be made available.

If it is determined at step 1006 that the final creative is not completely available, then control is transferred to step 1008. Otherwise, the final creative is made available and the final creative editorial cycle is considered complete. In a step 1008, at the end of a repeating specified period (the “final creative reminder period”) the advertiser is reminded to make the final creative available well before the campaign launch. In some embodiments, e-mail is used to remind the advertiser.

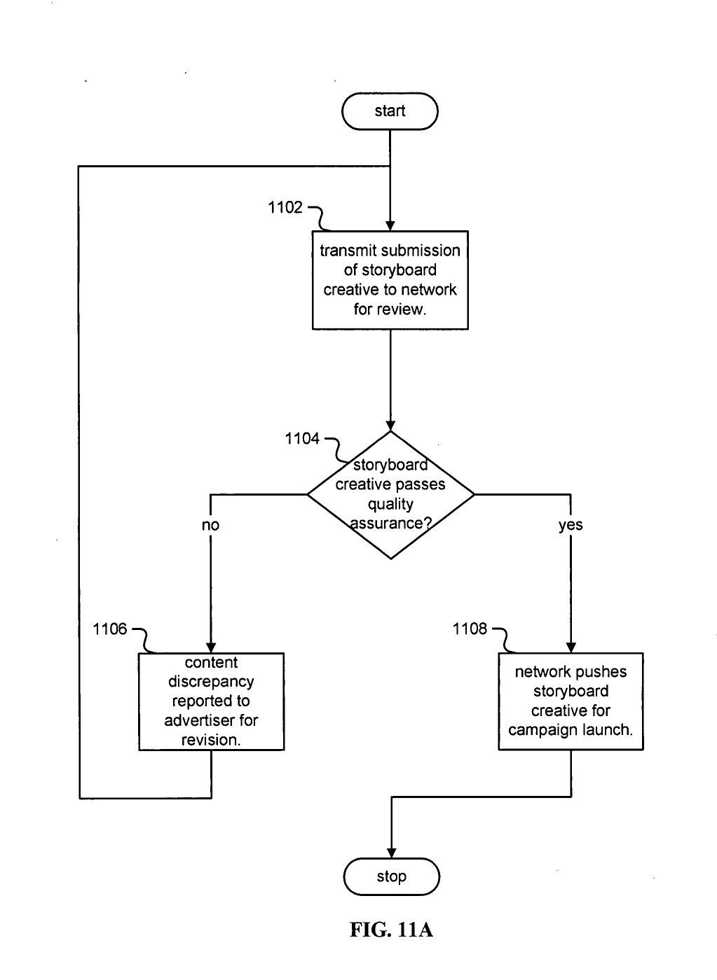

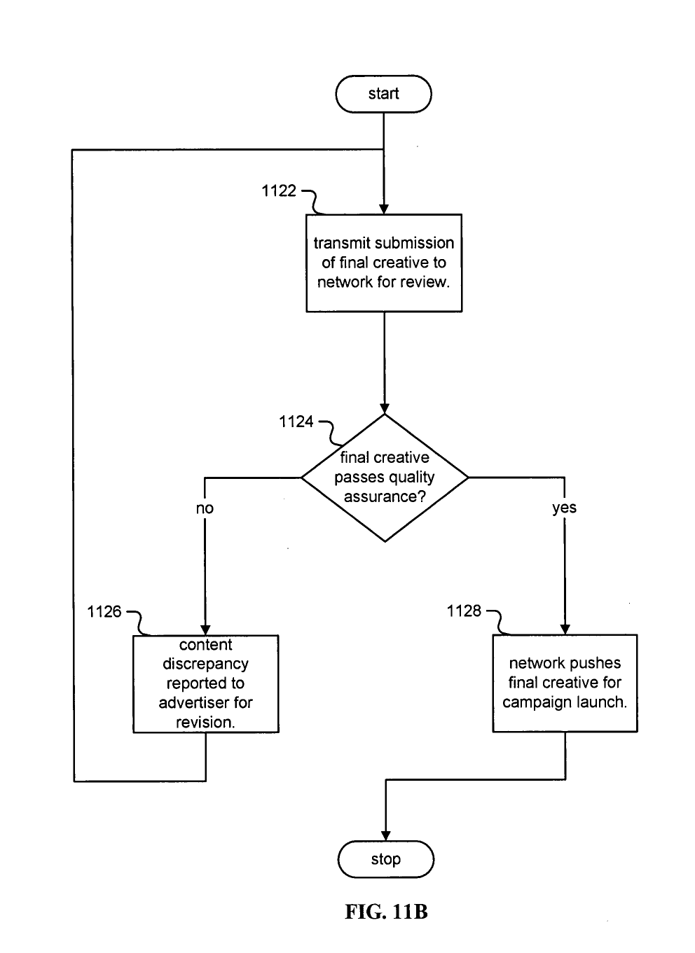

FIG. 11A is a flowchart illustrating an embodiment of a process for storyboard creative quality assurance. In some embodiments, the process of FIG. 11A is included in 706 of FIG. 7. The process may be implemented in demand web server 306, business logic server 308, supply server 312, or a combination of the three.

In a step 1102, the storyboard creative is made available to the location based advertising networks for review. In some embodiments the storyboard creative is available on supply server 312, business logic server 308, or both. In some embodiments, the storyboard creative can be downloaded using FTP or secure FTP. The location based advertising networks then review the storyboard creative for content and technical specification compliance, which if positive passes quality assurance.

If it is determined in a step 1104 that the location based advertising networks determine the storyboard creative does not pass quality assurance, then control is transferred to step 1106. If it is determined in a step 1104 that the location based advertising networks determine the storyboard creative passes quality assurance, then control is transferred to step 1108.

In a step 1106, the content discrepancy is reported to the advertiser for revision. Depending on the scale of the discrepancy, the advertiser may follow the process of FIG. 9 or FIG. 10 one or more times to resolve the discrepancy. Control is then transferred back to step 1102 for a review.

In a step 1108, the location based advertising networks push the storyboard creative for a campaign launch, by downloading the storyboard creative to the associated players 206 and setting the appropriate schedules 216 with the location based advertising campaign loops 220.

FIG. 11B is a flowchart illustrating an embodiment of a process for final creative quality assurance. In some embodiments, the process of FIG. 11B is included in 710 of FIG. 7. The process may be implemented in demand web server 306, business logic server 308, supply server 312, or a combination of the three.

In a step 1122, the final creative is made available to the location based advertising networks for review. In some embodiments the final creative is available on supply server 312, business logic server 308, or both. In some embodiments, the final creative can be downloaded using FTP or secure FTP). The location based advertising networks then review the final creative for content and technical specification compliance, which if positive passes quality assurance.

If it is determined in a step 1124 that the location based advertising networks determine the final creative does not pass quality assurance, then control is transferred to step 1126. If it is determined in a step 1124 that the location based advertising networks determine the final creative passes quality assurance, then control is transferred to step 1128.

In a step 1126, the content discrepancy is reported to the advertiser for revision. Depending on the scale of the discrepancy, the advertiser may follow the process of FIG. 9 or FIG. 10 one or more times to resolve the discrepancy. Control is then transferred back to step 1122 for a review.

In a step 1128, the location based advertising networks push the final creative for a campaign launch, by downloading the final creative to the associated players 206 and setting the appropriate schedules 216 with the location based advertising campaign loops 220.

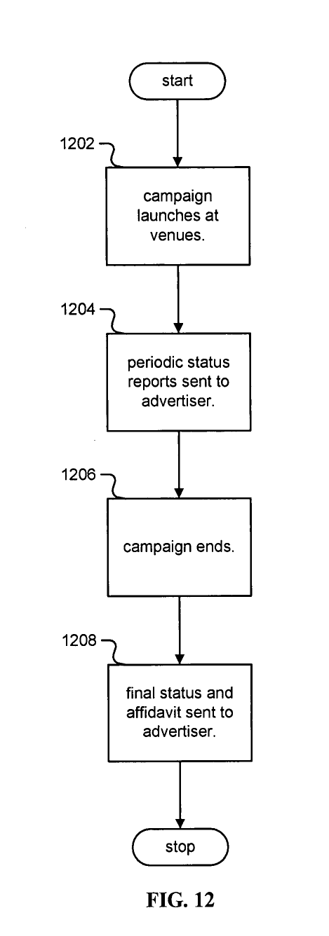

FIG. 12 is a flowchart illustrating an embodiment of a process for a location based advertising campaign launch and end. In some embodiments, the process of FIG. 12 is included in 712 of FIG. 7. The process may be implemented in business logic server 308 or network server 314.

In a step 1202, the campaign launches at the associated venues using players 206 on screens 208 for consumers 222. In a step 1204, a status report is sent at the end of a repeating specified period (the “status period”). In some embodiments the status period is a month. In some embodiments, the status report includes a log indicating the status of the associate players 206 over time. In some embodiments, the status report includes an invoice for the advertiser.

In a step 1206, the campaign ends. The location based advertising networks remove the loops from schedule 216 and from player 206. In a step 1208, a final status and affidavit is sent to the advertiser. In some embodiments, the affidavit is based partially on “Proof of Play”, play validation data, with a log of when each specified loop was confirmed to have been played. In some embodiments, the affidavit matches units of net impressions with those of the number of plays, taking into account mean time between failures (MTBF) of the associated hardware and log coverage of the duration of the campaign.

For example, if a campaign has venues that total 320,000 net impressions, has 20,160 possible total plays of the campaign's loop, and a MTBF of 90%, then it is held for the affidavit that 320,000 net impressions is equivalent to 90% of 20,160, or 18,144 plays.

To further the same example, if a campaign has a log coverage of 80%, then 18,144 plays multiplied by 80% is the 14,515 expected plays during log coverage. Similarly the net impressions expected during log coverage is the 320,000 net impressions multiplied by 80%, or 256,000 net impressions during log coverage. If the logs only show 12,000 actual plays, then a performance score of 12,000 over 14,515 plays, or 83% is assigned.

To further the same example, the performance score is multiplied by the net impressions expected during log coverage, or 83% is multiplied by 256,000 to give the performance adjusted impression count of 211,640. A linear adjustment can then be made to refund some of the cost of the location based advertising campaign based on any reduction in the impression count. In some embodiments, a specified threshold is used to indicate whether or not to refund the cost of the location based advertising campaign, to ensure only significant amounts of money are refunded.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for determining a location based advertising campaign, including:
a processor; and
a memory coupled with the processor, wherein the memory is configured to provide the processor with instructions which when executed cause the processor to:
receive a specification of the location based advertising campaign characteristics;
score available spots in an advertising supply based on the specification;
automatically determine selected spots from among the available spots in physical locations to include in the location based advertising campaign, based on an advertising budget and the scoring of the available spots; and
output a description of the location based advertising campaign for displaying the selected spots.

2. A system as recited in claim 1 wherein a spot includes a location and timing of a venue.

3. A system as recited in claim 1 wherein the specification of location based advertising campaign characteristics include a specification of net impressions.

4. A system as recited in claim 1 wherein the specification of location based advertising campaign characteristics include a specification of net impressions, wherein net impressions are determined by a traffic number multiplied by an awareness factor.

5. A system as recited in claim 1 wherein the specification of location based advertising campaign characteristics include categories.

6. A system as recited in claim 1 wherein the specification of location based advertising campaign characteristics include a specification of categories, wherein categories include hierarchical associations or keyword associations.

7. A system as recited in claim 1 wherein the specification of location based advertising campaign characteristics include a specification of geographic location.

8. A system as recited in claim 1 wherein the specification of location based advertising campaign characteristics include a specification of geographic location, wherein geographic location is specified as one of an address, a radius from a set of known locations, a latitude and longitude pair, a DMA, or a CSA.

9. A system as recited in claim 1 wherein the specification of location based advertising campaign characteristics include a specification of venues.

10. A system as recited in claim 1 wherein the specification of location based advertising campaign characteristics include a specification of venues, wherein venues include demographics and placement.

11. A system as recited in claim 1 wherein the specification of location based advertising campaign characteristics include a specification of venues, wherein venues include demographics and placement, wherein demographics include age, gender, income and ethnicity.

12. A system as recited in claim 1 wherein the specification of location based advertising campaign characteristics include a specification of venues, wherein venues include audio requirements.

13. A system as recited in claim 1 wherein the specification of location based advertising campaign characteristics include a specification of timing.

14. A system as recited in claim 1 wherein the specification of location based advertising campaign characteristics include a specification of timing, wherein timing includes availability of allocated time on the loop.

15. A system as recited in claim 1 wherein the specification of location based advertising campaign characteristics include a specification of timing, wherein timing includes specified advertisement length.

16. A system as recited in claim 1 wherein the specification of location based advertising campaign characteristics include a specification of distribution.

17. A system as recited in claim 1 wherein the specification of location based advertising campaign characteristics include a specification of distribution, wherein distribution includes geographic distribution.

18. A system as recited in claim 1 wherein the specification of location based advertising campaign characteristics include a specification of distribution, wherein distribution includes category distribution.

19. A system as recited in claim 1 wherein the specification of location based advertising campaign characteristics include a specification of distribution, wherein distribution includes campaign week distribution.

20. A system as recited in claim 1 wherein the specification of location based advertising campaign characteristics include a specification of distribution, wherein distribution includes campaign week distribution, wherein campaign week distribution includes an even distribution, a front-end distribution, or a back-end distribution.

21. A system as recited in claim 1 wherein the scoring includes being multiplied by a priority weighting.

22. A system as recited in claim 1 wherein the advertising budget is specified in financial costs.

23. A system as recited in claim 1 wherein the advertising budget is specified in financial costs, maximum CPM.

24. A system as recited in claim 1 wherein the advertising budget is specified in impressions.

25. A system as recited in claim 1 wherein the processor is further configured to reserve the location based advertising campaign for a reservation period.

26. A system as recited in claim 1 wherein the processor is further configured to book the location based advertising campaign.

27. A method of determining a location based advertising campaign, including
receiving a specification of location based advertising campaign characteristics;
scoring available spots in an advertising supply based on the specification;
automatically determining selected spots from among the available spots in physical locations to include in the location based advertising campaign, based on an advertising budget and the scoring of the available spots; and
outputting a description of the location based advertising campaign for displaying the selected spots.

28. A method as recited in claim 27 wherein a spot includes a location and timing of a venue.

29. A method as recited in claim 27 wherein the specification of location based advertising campaign characteristics include a specification of net impressions.

30. A method as recited in claim 27 wherein the specification of location based advertising campaign characteristics include a specification of net impressions, wherein net impressions are determined by a traffic number multiplied by an awareness factor.

31. A method as recited in claim 27 wherein the specification of location based advertising campaign characteristics include categories.

32. A method as recited in claim 27 wherein the specification of location based advertising campaign characteristics include a specification of geographic location.

33. A method as recited in claim 27 wherein the specification of location based advertising campaign characteristics include a specification of venues.

34. A method as recited in claim 27 wherein the specification of location based advertising campaign characteristics include a specification of timing.

35. A method as recited in claim 27 wherein the specification of location based advertising campaign characteristics include a specification of distribution.

36. A method as recited in claim 27 wherein the specification of location based advertising campaign characteristics include a specification of distribution, wherein distribution includes campaign week distribution, wherein campaign week distribution includes an even distribution, a front-end distribution, or a back-end distribution.

37. A method as recited in claim 27 wherein the advertising budget is specified in financial costs.

38. A method as recited in claim 27 wherein the advertising budget is specified in impressions.
